(19) United States
(12) Patent Application Publication
(10) Pub. No.: US 2018/0043648 A1
(43) Pub. Date: Feb. 15, 2018

(54) METHOD AND APPARATUS FOR PRODUCING A PREFORM

(71) Applicant: WOBBEN PROPERTIES GMBH, Aurich (DE)

(72) Inventors: Alexander HOFFMANN, Emden (DE); Peter FRIEDE, Südbrookmerland (DE); Benjamin THEILE, Passau (DE)

(21) Appl. No.: 15/557,054

(22) PCT Filed: Mar. 9, 2016
(86) PCT No.: PCT/EP2016/054965

§ 371 Date: Sep. 8, 2017

(30) Foreign Application Priority Data
Mar. 12, 2015 (DE) 10 2015 204 490.4

(51) Int. Cl. B29D 99/00; B29C 33/68; B29C 70/32; B29B 11/16

(52) U.S. Cl. CPC B29D 99/0025; B29B 11/16; B29C 33/68; B29C 70/32; B29L 2031/085

(57) ABSTRACT

A method and an apparatus for producing a preform for a rotor blade of a wind turbine. The method comprises the steps of providing at least one semifinished textile product on at least one roll, applying a binder onto the semifinished textile product and/or heating the semifinished textile product, draping the at least one semifinished textile product from the at least one roll onto a core, and curing the semifinished textile product after the draping on the core. The draping is in this case carried out by means of rotating the core.

### BACKGROUND

### Technical Field

The present invention relates to a method for producing a preform for a wind turbine rotor blade, to a preform of a rotor blade of a wind turbine, to an apparatus for producing a preform for a rotor blade of a wind turbine, and to a wind turbine.

### Description of the Related Art

Wind turbines to be used for electricity generation are widely known, and are configured for example as in FIG. 1. Conventionally, the rotor blades of such a wind turbine are for the most part made of fiber composite materials. To this end, preforms close to final contour are used. The preform has a great influence on the production chain from the starting materials to the finished rotor blade. The preform should as far as possible replicate the geometry of the rotor blade. In general, it is known to produce such a preform in a half-shell by a manual method. Such a manual method is represented, for example, in FIG. 2.

FIG. 2 shows a mold 1 in which a semifinished textile product 2 is placed. The semifinished textile product 2 has a binder applied, i.e., is slightly adhesively bonded. Subsequently, a further layer of the semifinished textile product 2 is draped onto the first layer provided with the binder. The second layer then likewise has a binder applied. This is repeated until the required number of layers is reached. The mold 1 is in this case configured as a half-shell. In order to produce a rotor blade, it is therefore furthermore necessary to use at least two half-shells per rotor blade. Such a method is very time consuming and the application of the binder to the semifinished textile product is subject to quality variations. Furthermore, the fiber orientation of the semifinished textile product is often perturbed by folding during the draping process, so that the predetermined mechanical properties cannot be preserved in the preform.

In the German priority application on which the priority is based, the German Patent and Trademark Office has investigated the following documents: US 2007/0 125 488 A1; GB 2 485 248 A; U.S. Pat. No. 4,247,258 A; U.S. Pat. No. 4,273,601 A; DE 102 51 580 A1; DE 10 2007 049 347 A1; JPS54-159 476 A; EP 2 319 682 B1 and WO 2013/091 635 A1.

### BRIEF SUMMARY

Provided is a method of forming a preform for a rotor blade of a wind turbine together with good quality and little time expenditure. At least, an alternative solution is to be proposed.

Provided is a method for producing a preform for a rotor blade of a wind turbine. The method comprises the steps: providing at least one dry semifinished textile product on at least one roll, applying a binder onto the semifinished textile product and/or heating the semifinished textile product, draping the at least one semifinished textile product from the at least one roll onto a core, and curing the semifinished textile product after the draping on the core. The draping is carried out by means of rotating the core. The preform is separated and may be used in the production of a rotor blade of a wind turbine.

In the present case, a semifinished textile product is intended in particular to mean flat semifinished products, for example scrims, fabrics or wovens as well as 3D semifinished products such as 3D fabrics or multiaxial scrims. In particular, glass-fiber scrims are used for the method. These semifinished textile products are provided on a roll as finished web material.

The semifinished textile product is in this case preferably dry, i.e., without a matrix being introduced into the semifinished product and only consisting of the corresponding processed fibers. A dry semifinished textile product is a semifinished textile product which is not impregnated with resin, i.e., the dry semifinished textile product is resin-unimpregnated. Optionally, the dry semifinished textile product may have a binder. The semifinished textile product may optionally constitute a prepreg.

Furthermore, either this semifinished textile product is already wetted with a binder on the roll or the binder is applied in an intermediate step between the unrolling of the semifinished textile product from the roll and the draping of the semifinished textile product onto the core. The binder is in this case intended to contribute to fixing the geometry and the coherence of the individual layers on the core. To this end, the binder is either applied directly as an adhesion promoter and/or it is heated by means of a heat source. It then remains tacky until it is cooled again and then maintains the adhesive bond set up with other layers. This gives rise to a preform which is sufficiently stable for the subsequent working steps, for example, in the case of a dry semifinished textile product, the application of infusion tools for introducing resin into the dry semifinished textile product.

After the semifinished textile product has been draped or wound onto the core, in the case of a dry semifinished product, a resin is optionally diffused in and subsequently cured. The binder must not be cured in this case. For application, it may be heated above the melting temperature and solidified after cooling below the melting temperature. As an alternative, the resin infusion is not carried out until after the preform has been placed in a rotor blade shell for producing the rotor blade.

So that the semifinished product is placed on the core, the core rotates, in particular by means of a motor drive. By this method, it is possible to permit uniform wetting of the semifinished textile product with a binder, so that quality variations are avoided. Furthermore, the semifinished textile product is draped automatically on the core by the rotation of the core, so that the method is less time-consuming than a corresponding manual method. Furthermore, simple, i.e., less elaborate, production of such a preform is therefore ensured.

Preferably, the semifinished textile product has a first side facing away from the core and a second side facing toward the core, and the first side and/or the second side is wetted with the binder between the roll and the core. The semifinished product is thus automatically wetted with a binder, or has a binder applied, during the placement of the semifinished product on the core. In particular, binder is applied or sprayed onto the semifinished product from above, i.e., onto the first side, or from below, i.e., onto the second side, so that the binder is distributed uniformly on the semifinished product. This has the advantage that the time required for this production process is reduced and particularly uniform application of binder to the semifinished product, and therefore a uniform adhesive bond between the individual layers, is achieved.

Preferably, the application of the binder is carried out before the provision of the semifinished textile product. The semifinished textile product rolled onto the roll is thus provided with a binder. By omitting the step of binder application during the draping of the semifinished textile product onto the core, time is saved during production of the preform. The total duration of the production of the rotor blade is thereby reduced.

In one preferred embodiment, an application pressure is applied onto the semifinished textile product during the draping onto the core. The application pressure may, for example, be produced by a press roll or a roller, which rotates in the opposite direction to the core and is provided over the entire length of the core. By the application pressure, the adhesive bond between the individual layers of the semifinished textile product is strengthened and a stable preform is therefore ensured.

In one particularly preferred embodiment, the preform is separated, for example centrally, after the curing. The preform is thus separated through the middle so that two preforms are obtained. In particular, the preform is separated in the middle by means of a saw. By this method, a great time saving is achieved in comparison with a manual method in which the two preforms have to be produced individually. The two preforms are used for producing a wind turbine rotor blade.

In one preferred embodiment, the draping of the at least one semifinished textile product is carried out by means of a movement towards a longitudinal axis of the core. The semifinished textile product is accordingly guided along the roll lengthwise over and/or laterally to the core. The rolls with the semifinished textile product in this case move, in particular, with a speed corresponding to the rotational speed from a first end of the core to a second end of the core. In this way, uniform application of the semifinished textile product onto the core is ensured. Furthermore, it is thereby possible to use a roll with a handleable size.

Preferably, the method comprises the further step of arranging at least one separating element for producing an undercut at an intended separating position of the preform before the draping of the semifinished textile product. Such a separating element is, for example, configured as a part of the core or arranged as a separate element on the core. The separating element is, in particular, configured as a nonpermanent core, and is thus no longer present after the last step of the production method. In this case, the separating element is in particular made of sand, wax or a blown film. As an alternative, the separating element is made of plastic or wood. The separating element is arranged on the separating position in such a way that an undercut is formed there and separation of the preform into two half-shells is therefore facilitated. If the separating element remains on the core, or if it is arranged replaceably on the core, then the core is not damaged during the separation by a saw or the like. It can accordingly be used for a further production process.

In one preferred embodiment, a separating film, in particular a Hostaphan film, is arranged on the core before the draping of the semifinished textile product from the roll onto the core. The Hostaphan film functions in this case as a separating means. In this way, the preforms produced can be removed more easily from the core after the curing or solidification of the binder.

In one particularly preferred embodiment, the core is configured as an elongate oval body and is moved by a motor. This has the advantage that the core is produced by a simple design. The motor sets the core in rotation and therefore provides a predetermined forward feed force for winding the semifinished textile product onto the core. The rotational speed of the motor is in this case adjustable. Particularly uniform winding of the semifinished textile product onto the core is thereby ensured.

The elongate oval body in this case forms a surface, to be produced with the aid of the finished preform, of a rotor blade or rotor blade element. The uniformly produced preform ensures frictionless running of the further working steps for producing the rotor blade or rotor blade element. The total process time is shortened.

Preferably, in the method, from 2 to 30 rolls, in particular from 2 to 4 rolls, are used and/or at least two semifinished textile products on two rolls have a different fiber orientation and/or at least two semifinished textile products are draped in at least one different fiber orientation. Such a roll in this case has a weight of at least 500 kg. By using a plurality of rolls, it is possible to use different semifinished textile products and therefore to employ optimal use of the different properties of different composite materials. In particular, a different fiber orientation of the different semifinished textile products may be achieved by using a plurality of rolls. In this case, either the finished web materials already have different fiber orientations on the roll or the rolls are arranged in such a way that the semifinished products are applied onto the core at a different angle and are therefore wound onto the core correspondingly with different fiber orientations. Furthermore, roll replacement can be carried out easily in this way.

In one preferred embodiment, the core rotates once about its longitudinal axis in less than 25 seconds, particularly in 9 seconds. In this way, a first layer is in particular applied onto the core in 9 seconds. In this time, the individual layers obtain sufficiently good cohesion to one another. Particularly in the case of a very large number of layers, the time saving compared with a manual method is particularly great. This is particularly advantageous in regions in which a large number of layers need to be used, for example in the region of the rotor blade root, in which at least 40 layers are required. Since the semifinished textile product is draped in the dry state, the core can rotate more rapidly (than in the case of a wet semifinished product).

Further provided is a preform for a rotor blade of a wind turbine. The preform is in this case produced according to a method of the embodiment above. Such a preform has the advantage that it can be produced in large sizes, as is necessary for a rotor blade of a wind turbine. Furthermore, because of the method described above, it is subject to scarcely any quality variations and is therefore distinguished by its particularly high quality. By using such a preform, the duration of the entire process chain for the production of a rotor blade of a wind turbine is reduced.

Preferably, the preform is produced from at least one scrim, in particular a glass-fiber scrim. In this way, fiber orientations can be adjusted in wide ranges and mats or nonwovens may also be incorporated. Compared with a fabric, a scrim furthermore has an increased strength. A glass-fiber scrim is therefore favorable in production.

In order to achieve the object, an apparatus for producing a preform for a rotor blade of a wind turbine is furthermore proposed. The apparatus comprises in this case at least one roll, on which at least one semifinished textile product is arranged, at least one core, onto which the at least one semifinished textile product can be draped, a binder application device for wetting the at least one semifinished textile product with a binder and/or a heat source for heating the at least one semifinished textile product, as well as a drive device for setting the core in a rotational movement. The semifinished textile product can in this case be draped onto the core by the rotational movement of the core. The binder application device is in this case in particular a spray device, by which the semifinished textile product is provided with a binder. A heat source is intended in particular to mean a heating appliance, a heater, an oven or a heating path with infrared heat radiators, or heating by convection, i.e., a device which in particular heats the binder of the at least one semifinished textile product and therefore increases the tackiness. If the semifinished textile product is already provided with a binder on the roll, the roll is in particular arranged in an oven before the unrolling so that the individual layers of the tacky semifinished textile product adhere well to one another.

The apparatus is in this case advantageously configured simply, so that a preform can be produced rapidly and economically. The contexts, explanations and advantages according to at least one embodiment of the described method are therefore obtained.

Preferably, a movement device for moving the at least one roll in the direction of the longitudinal axis of the core is provided. The semifinished textile product is accordingly moved along the longitudinal axis, i.e., from a first end to a second end of the core, which is preferably oval or round in cross section, and draped. In this way, uniform and controlled application of the semifinished textile product on the entire core surface is ensured.

Preferably, a separating film, in particular a Hostaphan film, is arranged on the core. In this way, the preform produced can be removed simply and in an uncomplicated way from the core.

In one preferred embodiment, a separating element for producing an undercut is provided on the core at an intended separating position of the preform. Such a separating element may in particular be made of plastic, wood, sand or wax. In this way, the separating positions are already provided in the preform, or the preform can be separated easily at a corresponding position. The core is not damaged during the separation of the preform into two parts.

In one particularly preferred embodiment, a pressing apparatus is provided on the core. Such a pressing apparatus is, in particular, configured as a roller or a press roll which runs over the core. By way of the pressing apparatus, a predetermined application force is exerted on the semifinished product during the winding onto the core. In this way, the holding force of the individual layers of the semifinished product is improved.

Preferably, from 2 to 30 rolls, in particular from 2 to 4 rolls, are provided and at least two of the rolls have two semifinished textile products with different fiber orientations. In this way, the special properties of the semifinished textile products can be used particularly well.

Further provided is a wind turbine comprising a tower, a nacelle which is mounted rotatably on the tower, a rotor which is mounted rotatably on the nacelle, and a multiplicity of rotor blades fastened on the rotor. At least one of the rotor blades is produced with a preform according to one of the aforementioned embodiments. This has the advantage that the overall production time of such a wind turbine is reduced.

### BRIEF DESCRIPTION OF THE SEVERAL VIEWS OF THE DRAWINGS

The invention will be explained by way of example below with the aid of exemplary embodiments with reference to the appended figures. The figures contain in this case partly simplified schematic representations.

FIG. 1 shows a wind turbine in a perspective view,

FIG. 2 shows a method according to the prior art,

FIG. 3a shows a first method step of a method according to the invention,

FIG. 3b shows another first method step of a method according to the invention,

FIG. 3c shows a second method step according to one of the methods of FIG. 3a or FIG. 3b,

FIG. 3d shows two finished preforms for a rotor blade produced by a method according to FIGS. 3a or 3b and 3c, and

FIG. 4 shows a schematic sectional view of a wind turbine rotor blade according to the invention.

### DETAILED DESCRIPTION

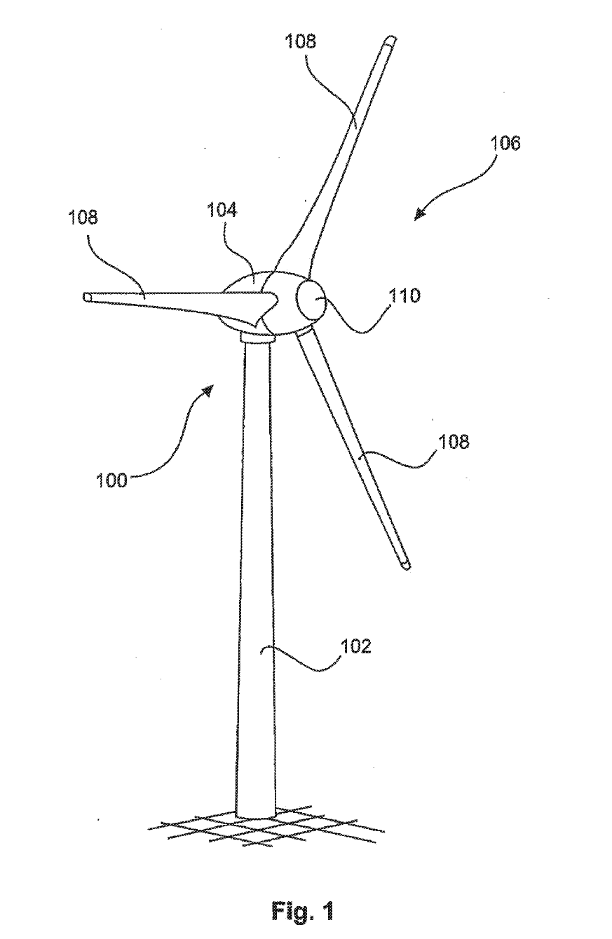

FIG. 1 shows a wind turbine 100 having a tower 102 and a nacelle 104. A rotor 106 having three rotor blades 108 and a spinner 110 is arranged on the nacelle 104. During operation, the rotor 106 is set in a rotational movement by the wind and thereby drives a generator in the nacelle 104.

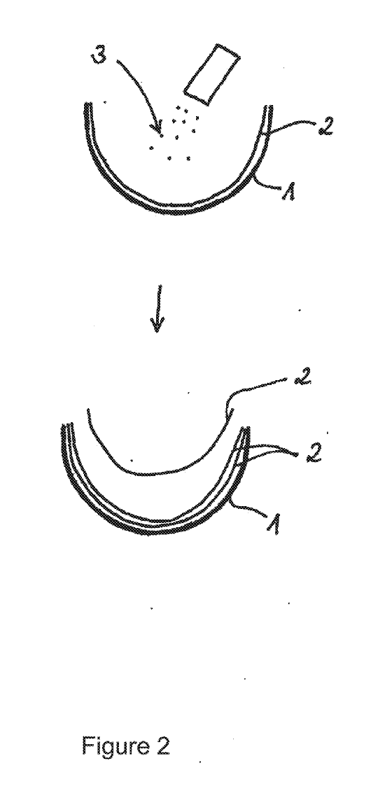

FIG. 2 shows a method step for the production of a preform of a rotor blade of a wind turbine according to the prior art. A mold 1 can be seen, in which a semifinished textile product 2 is placed and has a binder 3 applied to it. This is repeated until a sufficient number of layers of the semifinished textile product 2 are arranged in the mold 1. The mold 1 is in this case configured as a half-shell. In order to produce a complete rotor blade by this method, at least two half-shells per rotor blade are accordingly required. Such a method is therefore very time-consuming. Furthermore, the method is subject to quality variations because of the manual draping of the individual layers.

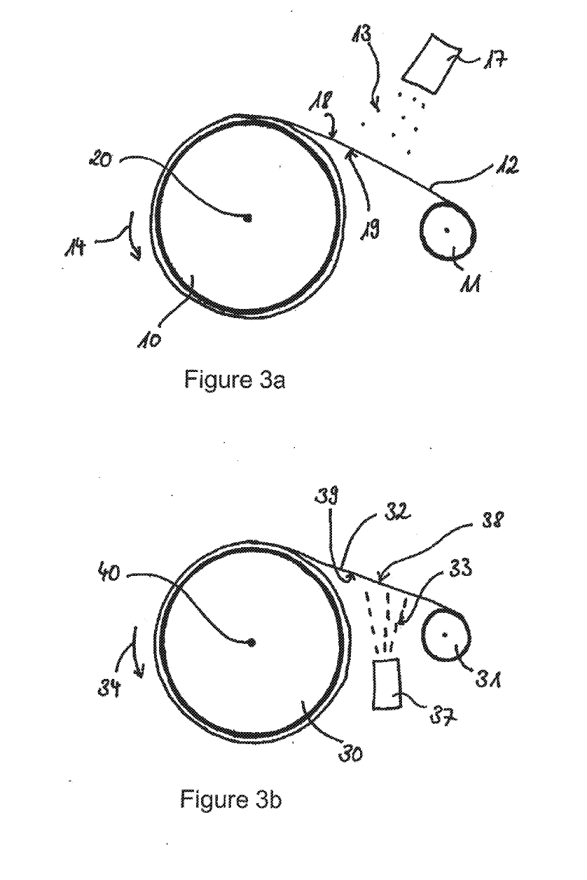

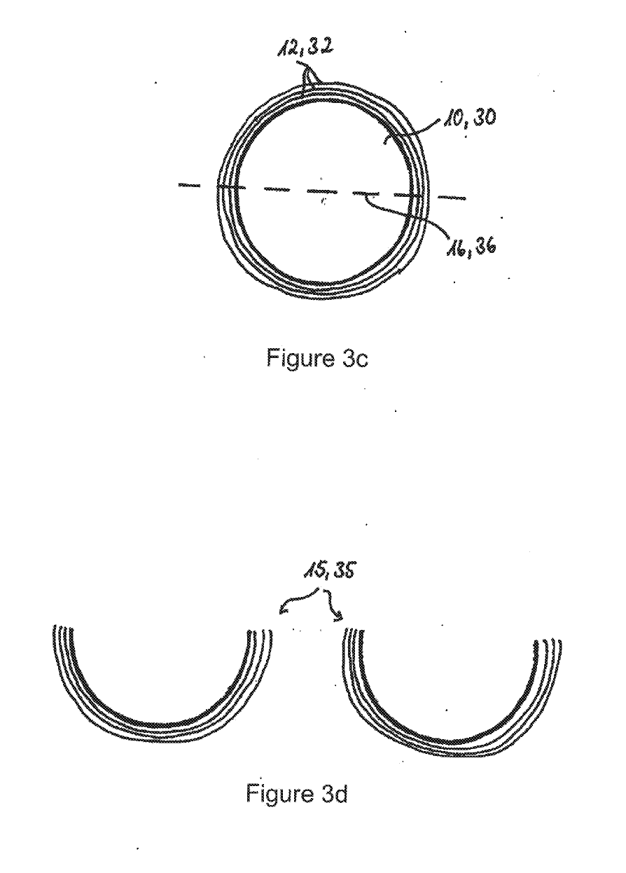

FIG. 3a shows a first method step of a method. FIG. 3a shows a core 10 and a roll 11, on which a scrim 12 made of fiber material, preferably of glass fibers, as an exemplary embodiment of a dry semifinished textile product, is rolled. The scrim 12 has a first side 18 and a second side 19. On the roll 11, it is not yet provided with a binder. A binder application device 17 is arranged between the core 10 and the roll 11. The core 10 is arranged rotatably in the direction of the arrow 14 about its longitudinal axis 20, preferably by means of a motor. In this way, the scrim 12 is automatically unwound from the roll 11 and wound onto the core 10.

In FIG. 3a, the scrim 12 is already partially rolled onto the core 10. During the process of rolling the scrim 12 onto the core 10, the scrim 12 has a binder 13 applied to it. In this case, the scrim 12 is wetted with the binder 13 on the first side 18, facing away from the core 10. On the second side 19, which is directed towards the core 10, no binder is provided. By this binder application, the scrim 12 is fixed. Undesired folds in the preform to be produced are thereby avoided. The preform produced in this way is stable and correspondingly prepared for the further working steps.

FIG. 3b shows another embodiment of a first method step of a method. FIG. 3b also shows a core 30 onto which a scrim 32 having a first side 38 and a second side 39 is partially rolled as an exemplary embodiment of a semifinished textile product. The scrim 32 is rolled from a roll 31 onto the core 30. The core 30 in this case rotates about its longitudinal axis 40 in the direction of the arrow 34. In contrast to FIG. 3a, the scrim 32 is wetted from below with a binder 33 between the roll 31 and the core 30 by means of a binder application device 37. The binder 33 is thus applied onto the second side 39.

As an alternative to what is shown in FIG. 3a and FIG. 3b, the scrim may already be provided with a binder on the roll. A corresponding binder application device is then no longer necessary. Furthermore, in addition to the binder application device or instead of the binder application device, a heat source such as a heat radiator, oven or the like may be provided, by which the binder is adhesively bonded and the adhesion of the individual layers is therefore strengthened.

In another alternative, the binder may be applied to the scrim on the roll. The binder application device is in this case, in particular, arranged directly above the roll.

FIG. 3c shows a second method step of a method according to FIG. 3a or FIG. 3b. FIG. 3c shows the core 10, 30. On the core 10, 30, the predetermined number of layers of the scrim 12, 32 for the preform to be produced has been achieved. The individual layers adhere well to one another. After the draping of the scrim 12, 32 onto the core 10, 30, the scrim 12, 32, if it is not yet provided with a matrix, is impregnated with one, or this impregnation process may also be carried out between the unrolling of the scrim 12, 32 from the roll 11, 31 onto the core 10, 30. After the draping, and optionally the impregnation, of the scrim with a resin or the like, the scrim is cured. After the curing, the scrim is separated centrally, i.e., on the midline 16, 36, so that two preforms 15, 35 as depicted in FIG. 3d are obtained therefrom. The two preforms 15, 35 are in this case configured as (preform) half-shells. A rotor blade or a rotor blade element is subsequently produced therewith.

The core may optionally rotate once about its longitudinal axis in less than 25 s, and particularly in less than 9 s.

In the case of a semifinished product already provided beforehand with a matrix, the semifinished product is directly cured after it has been wound on the core.

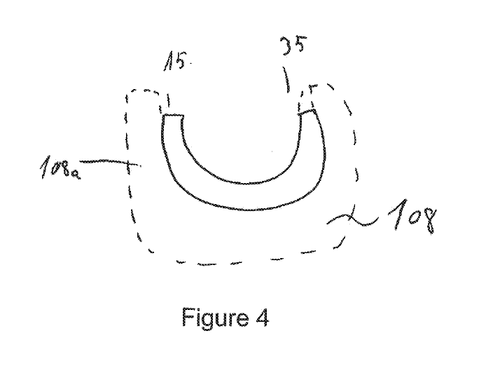

FIG. 4 shows a schematic sectional view of a wind turbine rotor blade.

A preform half-shell 15, 35 is part of the structure of the rotor blade 108. In other words, the preform half-shell 15, 35 is integrated into the rotor blade 108. In particular, a preform half-shell 15, 35 is integrated into a rotor blade half-shell.

A wind turbine rotor blade is produced, the two preform half-shells being used in the production of a wind turbine rotor blade.

The wind turbine rotor blade is assembled from two rotor blade half-shells, one of the two separated halves of the preform being used in each of the half-shells.

1. A method comprising:
producing a preform of a wind turbine rotor blade, wherein producing comprises:
providing at least one dry semifinished textile product on at least one roll,
at least one of applying a binder onto the at least one dry semifinished textile product or heating the at least one dry semifinished textile product,
draping the at least one dry semifinished textile product from the at least one roll onto a core by rotating the core,
after draping, curing the at least one dry semifinished textile product, and
separating the preform to obtain two preform half-shells.

2. The method according to claim 1, wherein the core rotates once about its longitudinal axis in less than 25 seconds.

3. The method according to claim 1, wherein the at least one dry semifinished textile product has a first side facing away from the core and a second side facing toward the core, wherein at least one of the first side and the second side is wetted with the binder between the roll and the core.

4. The method according to claim 1, wherein applying the binder occurs before providing the at least one dry semifinished textile product.

5. The method according to claim 1, wherein separating the preform comprises separating the preform at a center portion before or after the curing.

6. The method according to claim 1, wherein draping the at least one dry semifinished textile product comprise moving the at least one dry semifinished textile product towards a longitudinal axis of the core.

7. The method according to claim 1, wherein a separating film is arranged on the core before draping the at least one dry semifinished textile product from the roll onto the core.

8. The method according to claim 1, wherein the core is configured as an elongate oval body and is moved by a motor.

9. The method according to claim 1, wherein the at least one roll is between 2 and 30 rolls.

10. The method according to claim 1 further comprising applying pressure onto the at least one dry semifinished textile product while draping the at least one dry semifinished textile product from the at least one roll onto the core.

11. A method comprising:
producing a wind turbine rotor blade, wherein producing comprises:
providing at least one dry semifinished product on at least one roll,
at least one of applying a binder onto the at least one dry semifinished textile product or heating the at least one dry semifinished textile product,
draping the at least one dry semifinished textile product from the at least one roll onto a core by rotating the core,
after draping, diffusing resin into the at least one dry semifinished textile product to form an at least one wet semifinished textile product,
curing the at least one wet semifinished textile product to form an at least one cured semifinished textile product,
separating the at least one cured semifinished textile product into two preform half-shells, and
using the two preform half-shells to produce the wind turbine rotor blade by integrating two preform half-shells into the rotor blade.

12-13. (canceled)

14. An apparatus for producing a preform for a wind turbine rotor blade, the apparatus comprising:
at least one roll, at least one dry semifinished textile product is arranged on the at least one roll,
at least one core, the at least one semifinished textile product configured to be draped on the at least one core in response to the at least one core being rotated,
a binder application device configured to wet the at least one semifinished textile product with a binder,
a heat source configured to heat the at least one semifinished textile product, and
a drive device configured to set the at least one core in a rotational movement,
wherein the at least one core is configured to complete a full rotation in less than 9 seconds.

15. The apparatus according to claim 14, further comprising:
a movement device configured to move the at least one roll in a direction of a longitudinal axis of the at least one core.

16. The apparatus according to claim 14, wherein from 2 to 30 30 rolls, in particular from 2 to 4 rolls, are provided and at least two of the rolls have two semifinished textile products with a different fibre orientation.

17-18. (canceled)

19. The method according to claim 1, wherein the at least one dry semifinished textile product is two semifinished textile products on two rolls have different fibre orientations.

20. The method according to claim 1, wherein the at least one dry semifinished textile product is at least two semifinished textile products, wherein draping comprises draping the at least two semifinished textile products in different fibre orientations
